(19) United States
(12) Patent Application Publication
(10) Pub. No.: US 2003/0097445 A1
(43) Pub. Date: May 22, 2003

(54) Pluggable devices services and events for a scalable storage service architecture

(76) Inventors: Stephen Todd, Shrewsbury, MA (US); Michel Fisher, Natick, MA (US); Paul M. Bober, Lexington, MA (US)

Correspondence Address: DALY, CROWLEY & MOFFORD, LLP, SUITE 101, 275 TURNPIKE STREET, CANTON, MA, 02021-2310, US

(21) Appl. No.: 09/989,583

(22) Filed: Nov. 20, 2001

(51) Int. Cl. G06F 15/177

(52) U.S. Cl. 709/226; 709/221

(57) ABSTRACT

Modular resource configuration management in a service provider management system (SPMS) that connects to storage resources in a datacenter controlled by a service provider and a database that stores information about the datacenter and customers that receive the storage resources as a service is described. The SPMS enables the service provider to allocate storage resources to a customer, as well as to generate billing information based on storage resource configuration and customer usage. The SPSM software includes a device to monitor the resources for configuration and attributes/parameter information. The device is generalized to allow the monitored resources to be defined by corresponding executable modules. The executable modules thus present a common interface to the monitoring device, allowing the monitoring device to implemented in a generic (that is, resource-independent) manner.

### BACKGROUND

The invention relates generally to management of data storage resources.

Over the past decade, there have been changes in the marketplace that have had a significant impact on the corporate product delivery environment. Companies and corporate organizations that were at one time totally self-sufficient have chosen to focus development resources solely on products and services that relate to core competencies, and out-source all others. For example, companies that were not in the database business but once had their own proprietary databases have migrated to the use of off the shelf databases from software suppliers.

Further changes are occurring as such companies are faced with new competitive pressures and challenges. Efforts to scale infrastructure to meet ever-increasing demands in areas of bandwidth, computational power and storage are placing tremendous burdens on corporate enterprises. Also, because the World Wide Web has enabled commercial entities with little overhead and few resources to create the appearance of a business of the same type and scale as a much larger company, larger companies have found that they cannot afford the cost of the infrastructure changes if they are to remain competitive. Also of concern is the rising cost of services.

Consequently, companies looking for ways to do more with less are re-evaluating internal services to further refine their market focus, thus making way for a new set of out services and service providers, including the following: (i) the Internet Service Provider (ISP) to provide connectivity; (ii) the Storage Service Provider (SSP) to provide storage resources, e.g., allocate usage of storage devices; (iii) the Application Service Provider (ASP) to provide computational platforms and applications; (iv) the Floorspace Service Provider (FSP) to provide floorspace for rent with all the necessary connections; and the Total Service Provider (TSP) to provide all of the services of providers (i) through (iv) in one package. All of these service providers can be referred to generally as “xSPs”.

In addition, just as companies are relying more on out-sourcing of products and services, Information Technology (IT) departments within the largest of companies look to reposition themselves as TSPs for their internal customers. They may use outside service providers, but that out-sourcing will be hidden from the internal user. This service delivery approach translates into an environment of tiered service providers—each one providing the same services to each of their customers.

### SUMMARY

In one aspect, the invention provides methods and apparatus, including computer program products, for managing resources. The methods include: (i) connecting to the resources; (ii) providing executable modules corresponding to the resources, the modules each implementing a common interface and corresponding to a different one of the resources; (iii) making calls to the common interface in each of the executable modules to cause the executable modules to return information about the corresponding resources; and (iv) storing the information about the corresponding resources in a database.

Particular implementations of the invention may provide one or more of the following advantages.

The present invention provides a flexible, modular approach to managing resources, such as devices and/or services residing in an xSP environment. Base management software can be generalized so that it maintains an up-to-date view of any managed resource. That is, the base management software need not be tied to specific types of devices or services. It uses a common interface to call routines in executable modules, which, in turn, are defined to communicate with and describe the specific devices and services that they represent. New resources can be added to the xSP environment without changes to the base management software by simply installing a software upgrade that includes an executable module for each new resource. The modules can be used to provide for customizable events as well.

Other features and advantages of the invention will be apparent from the following detailed description and from the claims.

### DESCRIPTION OF DRAWINGS

FIG. 1 is a depiction of an exemplary storage service delivery and management environment including a Service Provider Management System (SPMS) server that enables an xSP to provide storage and storage-related services to a customer (CxSP) as a service.

FIG. 2 is a depiction of an exemplary multi-customer storage service delivery and management environment in which multiple SPMS servers are deployed within an xSP.

FIG. 3 is a depiction of an exemplary tiered storage service delivery and management environment.

FIG. 4 is a flow diagram illustrating interaction between an xSP and a “new” CxSP.

FIG. 5 is a block diagram of an exemplary SPMS server software architecture.

FIG. 6 is a depiction of various database tables created and maintained by the SPMS server.

FIG. 7 is a flow diagram illustrating an initial SPMS software installation process that installs executable modules defined to represent and communicate with storage resources residing in the xSP, and being usable by a configuration poller to monitor those resources over time.

FIG. 8 is a flow diagram illustrating the operation of the configuration poller.

FIG. 9 is flow diagram illustrating a process of installing SPMS software that is an upgrade to support new resources added to the xSP.

FIG. 10 is a depiction of an exemplary xSP for which initial SPMS software, including executable modules, has been installed on the SPMS server.

FIG. 11 is a depiction of an exemplary interface that allows an Administrator of the xSP of FIG. 10 to select those of the resources to be monitored by the configuration poller via the executable modules.

FIG. 12 is a depiction of the xSP (of FIG. 10) for which an upgrade of the SPMS software, including new executable modules, has been installed on the SPMS server.

Like reference numbers will be used to represent like elements.

### DETAILED DESCRIPTION

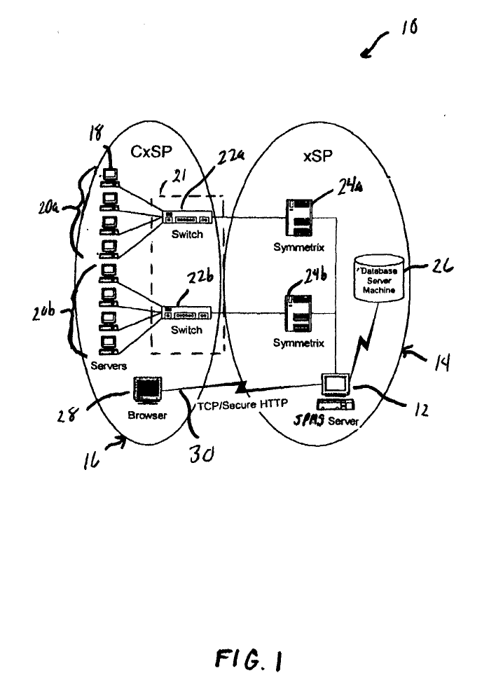

FIG. 1 illustrates an exemplary storage service delivery and management environment 10. Storage provisioning and service management are enabled by a device referred to hereinafter as a Service Provider Management System (SPMS), which is implemented as a server architecture and thus operates on a server machine shown as the SPMS server 12. The SPMS provides the necessary tools to allow service providers to grow a business around their ever-growing datacenters.

There are two target users of the SPMS server 12: an xSP 14 and a customer of the xSP (or “CxSP”) 16. In the embodiment shown, the CxSP 16 includes a plurality of host servers 18. The servers 18 are connected to an interconnect 21, which can be a switch-based or hub-based configuration, or some other Storage Area Network (SAN) interconnect. In one embodiment, the interconnect 21 includes one or more switches 22, shown in the figure as a pair of switches 22a and 22b. Thus, some of the servers 18 in a first group 20a are connected to the switch 22a, and the other servers 18 (in a second group 20b) are connected to the other switch 22b. The switch 22a is connected to a first storage system 24a and the switch 22b is connected to a second storage system 24b. Collectively, the storage systems 24 represent a datacenter within the xSP. Each storage system 24 includes one or more data storage resources, such as a storage device (e.g., disk) or a storage-related service (e.g., data mirroring). For illustrative purposes, the storage systems 24 are shown as Symmetrix storage systems, which are available from EMC Corporation, and the operation of the server 12 is described within the context of a scalable Symmetrix storage infrastructure. However, the storage infrastructure could include other storage system platforms and media types. It will be assumed that the storage in the Symmetrix systems 24 has been segmented into usable chunks.

The storage systems 24 each are connected to the SPMS server 12. Also connected to the SPMS server 12 and residing in the xSP 14 is a database server 26. The database server can be implemented as an Oracle database server or any other commercially available database system. The database server 26 is used to store hardware management and customer information.

As will be further described below, SPMS server architecture can be configured for a number of different service model permutations. In one service model, the CxSP owns the servers and perhaps the switches (as shown in the FIG. 1), which are connected to ports on the storage systems 24 maintained by the xSP, and may or may not allow integration of SPMS components with those servers. In another service model, the xSP owns the servers 18 and/or the switches 22, in addition to the storage systems 24.

In addition to the servers 18 and switches 22, the CxSP 16 includes a browser/GUI 28, which is used as a CxSP console and allows an administrator for the CxSP 16 to perform tasks such as viewing the amount of used and free storage, assigning storage to the servers 18, viewing usage reports and billing information, reports on the general health of the CxSP storage, and other information. The CxSP 16 can run browser sessions from multiple clients simultaneously. The connection from the SPMS client browser 28 to the SPMS server 12 is a TCP connection running secure HTTP, indicated by reference numeral 30. The connection 30 can be a point-to-point Ethernet intranet that is directly cabled from the CxSP 16 to the xSP 14, or some other type of point-to-point network connection that supports TCP/IP transmissions. It should be noted that the SPMS server 12 actually exports two HTTP interfaces: one for the CxSP administrator (via the browser/GUI 28) and another for an xSP administrator (also using a Web-based GUI, not shown).

In one embodiment, the SPMS server 12 is a Solaris machine running an Apache Web server, as will be described. The server 12 communicates with the database server 26 to store and retrieve customer and storage system (e.g., Symmetrix) information. Of course, the database and the SPMS software could run on the same server. In an xSP environment that maintains multiple SPMS servers, however, the database should be accessible from any one of those SPMS servers located in the same xSP environment, as will be described later.

The SPMS server 12 links storage usage to customer accounts. The SPMS server 12 accomplishes this linkage by associating customer account information with the World Wide Name (WWN) of the Host Bus Adapter (HBA) that is installed on each server 18 in the CxSP 16 and uses the storage, and storing each association in the database 26.

Thus, the SPMS server 12 connects to storage (the storage to be managed, e.g., individual storage systems or systems that may belong to a datacenter or SAN) and the database 26 to store information about the storage and the customers who are receiving the storage as a service. As will be described in further detail below, the SPMS server 12 allows both xSPs and CxSPs to view, change and request storage-related information, as well as assign ownership to billable devices, for example, disks, volumes, ports, switches, servers, server Host Bus Adaptors (HBAs), among others. Multiple levels of ownership can be assigned, including ownership by the service provider (as far as who is responsible for administration of that device), ownership by the customer of the service provider, and sharing of devices by multiple customers (e.g., port-sharing). The SPMS server 12 also allows a service provider to generate billing information based on hardware configuration and customer usage of the configuration, and track events and services (such as mirroring or data backup, for example).

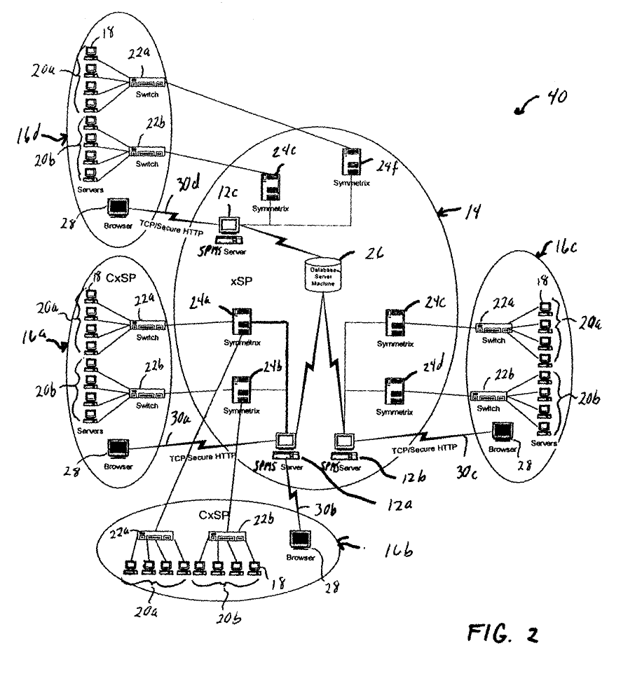

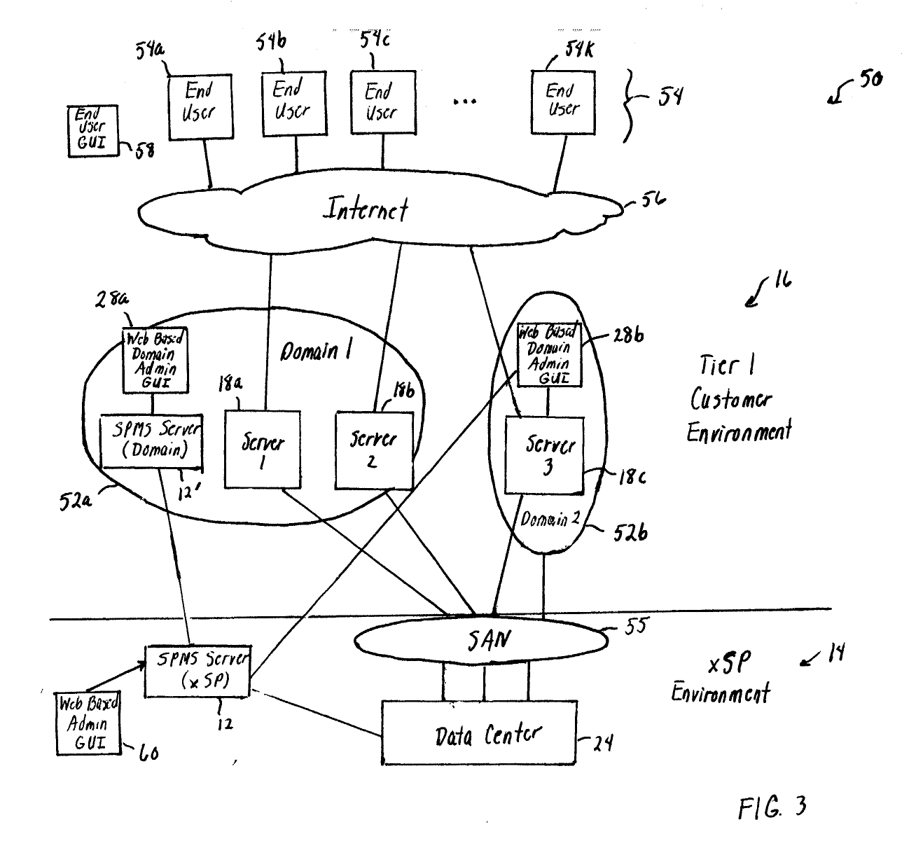

FIG. 2 illustrates a multi-customer environment 40 in which multiple clients 16 are being served by the xSP site, which has been scaled to include multiple storage system systems 24 as well as multiple SPMS servers 12. The multiple CxSPs 12, shown in this example as four CxSPs 16a, 16b, 16c and 16d, are supported within the environment of the xSP 14. The xSP maintains three SPMS servers, 12a, 12b and 12c, each of which is connected to and manages some subset of available storage systems 24a, 24b, . . . , 24f. In particular, server 12a is connected to storage systems 24a and 24b, the server 12b is connected to storage systems 24c and 24d, and the server 12c is connected to storage systems 24e and 24f.

Servers 18 and switches 22 belonging to CxSP 16a and CxSP 16b are connected to the Symmetrix units 24a, 24b, as shown, which in turn are connected to the SPMS server 12a. The browsers in both CxSPs 12a and 12b are able to communicate with the SPMS server 12a over their respective TCPs connections 30a and 30b to the SPMS server 12a. Therefore, one or more clients can be added to the ports on the Symmetrix units, as well as to an SPMS server that is connected to and manages those Symmetric units. In addition, new storage systems can be added at the xSP site. Each new box would need to be connected to an SPMS server. The xSP also has the option of scaling the solution further by introducing new SPMS servers that are connected to new Symmetrix units, as is illustrated with the addition of servers 12b and 12c. Each new SPMS server has access to the database server 26. Preferably, each SPMS server is responsible for a certain set of storage systems so that there is no overlap among the SPMS servers and the storage systems for which they are responsible. Additionally, if the xSP is concerned about failure of the SPMS server or database server, the SPSM servers and database can be clustered for high availability. The xSP has the option of sharing multiple ports among several customers or dedicating ports exclusively to specific customers.

FIG. 3 shows a tiered, managed storage infrastructure environment 50 that includes one or more customer domains 52, e.g., domains 52a (“domain 1”) and 52b (“domain 2”), and one or more end user systems 54, e.g. end user systems 54a, 54b, 54c, . . . , 54k. Each customer domain 52 is a logical collection of one or more “domain” servers 18 that are tracked for a single customer. In the example shown, the domain 52a includes servers 18a and 18b, and domain 52b includes server 18c. The servers 18a, 18b, and 18c are connected to the datacenter 24 via a SAN 55. In this illustration, the SAN 55 resides in the xSP environment 14 and includes one or more SAN interconnection devices such as Fibre Channel switches, hubs and bridges. A single customer may have multiple domains. In this environment, the xSP SPMS Server12 provides to each of the customer domains 52 a Web interface to available storage and storage services in the datacenter 24. The server 12 also tracks usage of each of the services. Associated with each of the services is one of end user systems 54, which communicate with the servers 18a, 18b, and 18c over the Internet 56 using their own GUIs, represented in the figure by end user GUI 58, and one of domain Administrators (via Adminstration GUIs 28a and 28b). The services can include, but need not be limited to, the following: storage configuration, which create volumes and place the volumes on a port; storage-on-demand to enable the end user to allocate storage in a controlled fashion; replication to enable the end user to replicate data from one volume to another in controlled fashion; disaster tolerance management service, if disaster tolerance is available and purchased by the customer; Quality of Service (QoS), which is provided only to the Administrator for controlling performance access; management of data backup services; logging, which logs all actions that take place on the SPMS Server; data extract/access—data is stored in the database and can be accessed or extracted by the Service Provider to pass the information into the billing system. The xSP Adminstrator uses an xSP Web based Administration GUI 60 as an interface to manage the entire environment.

The Web based Domain Administration GUIs 28a and 28b are the Web based interfaces used by the domain administrators for domains 52a and 52b, respectively. Each connects directly to the Service Provider's SPMS server 12 or, alternatively, to a local domain SPMS server (shown as SPMS server 12′) and proxies into the xSP environment.

The end user GUI 58 allows a domain end-user, e.g., 54a, to provide a business function to users of that business function. The end-user 54 can also provide storage services through this GUI and a domain SPMS server such as the domain SPMS server 12′.

Thus, the SPMS server 12 can be adapted for deployment in the customer and even the end-user environment, enabling the end-user to cascade out the services. Of course, the SPMS server provides different functionality in the xSP, customer and end user modes.

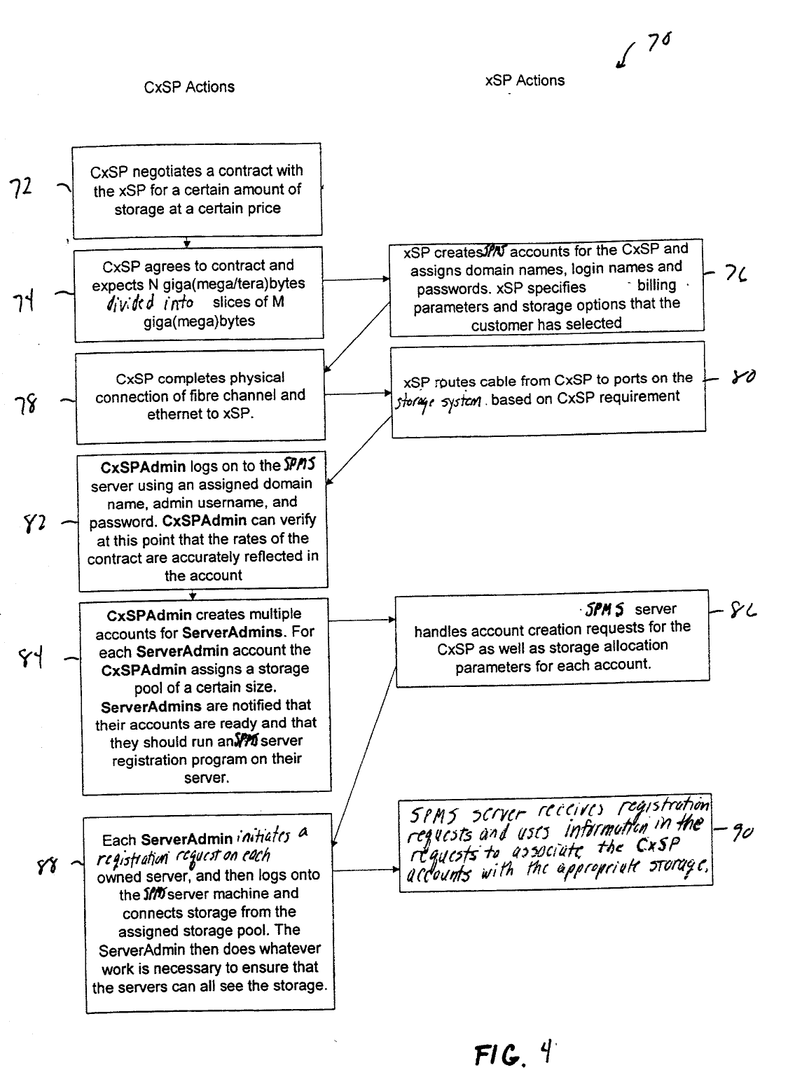

Before turning to the specifics of the software architecture, it may be helpful to examine the interaction between a new CxSP and an xSP SPMS server when that CxSP acquires storage for the servers in the CxSP environment. FIG. 4 shows a process of associating storage with a CxSP 70 and involves both CxSP actions and xSP actions. The main actions on the part of the CxSP are performed by the Server Administrator (“ServerAdmin”) in charge of administration of the storage connected to a given server, and the CxSP Administrator (“CxSPAdmin”) in charge of procuring more storage and authorizing it for use by the Server Administration and given server. This process flow assumes that the xSP has already acquired storage and divided that storage into partitions and sizes.

Referring to FIG. 4, the CxSP negotiates a contract with the xSP for a certain amount of storage at a certain price (step 72). Once the parties have agreed to the contract (step 74), the xSP creates SPMS accounts for the CxSP and assigns to the CxSP domain names, login names and passwords for use by the CxSP, and specifies billing parameters and storage options that the CxSP has selected under the agreement (step 76). The CxSP completes the physical connection (e.g., Fibre Channel and Ethernet) to the xSP machines (step 78). The xSP provides the physical connection from the CxSP equipment (e.g., the switches) to ports on the storage system based on the CxSP requirements (step 80). The CxSPAdmin logs onto the SPMS server using an assigned domain name, user name and password, and verifies that the contract terms (e.g., rates) are accurately specified in the account (step 82). The CxSPAdmin creates multiple accounts for ServerAdmins. For each ServerAdmin account, the CxSPAdmin assigns a storage pool of a certain size. The CxSPAdmin notifies the ServerAdmins that their accounts are ready and that they should run an SPMS server registration program on their respective servers (step 84). The SPMS server handles account creation requests for the CxSP as well as storage allocation parameters for each account (step 86). Each ServerAdmin initiates a registration request on each owned server (using the registration program) and logs onto the SPMS server to connect storage from the assigned pool. The ServerAdmin does whatever work is needed to ensure that the servers can see all of the storage allocated to those servers (step 88). The SPMS server receives the registration requests of each server, and uses information in the registration requests to associate the CxSP accounts with the appropriate storage (step 90).

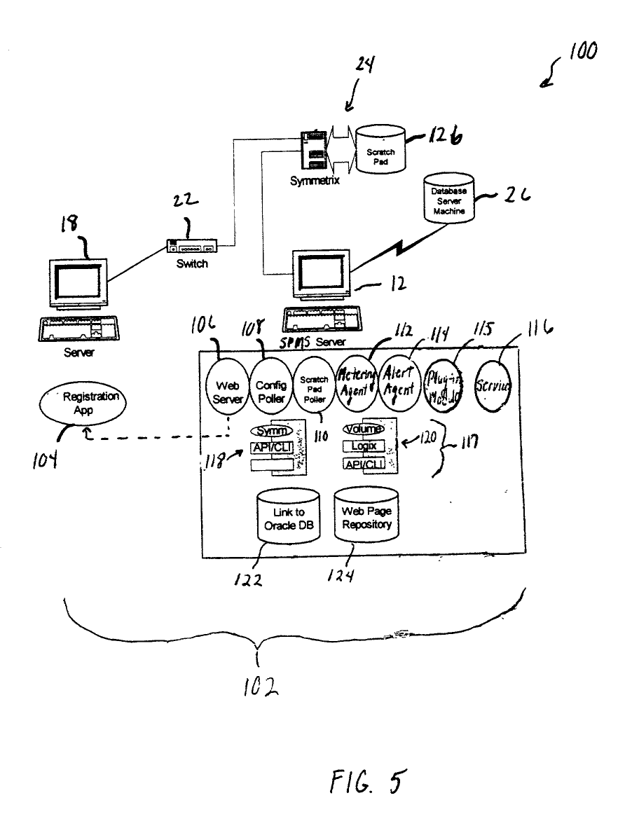

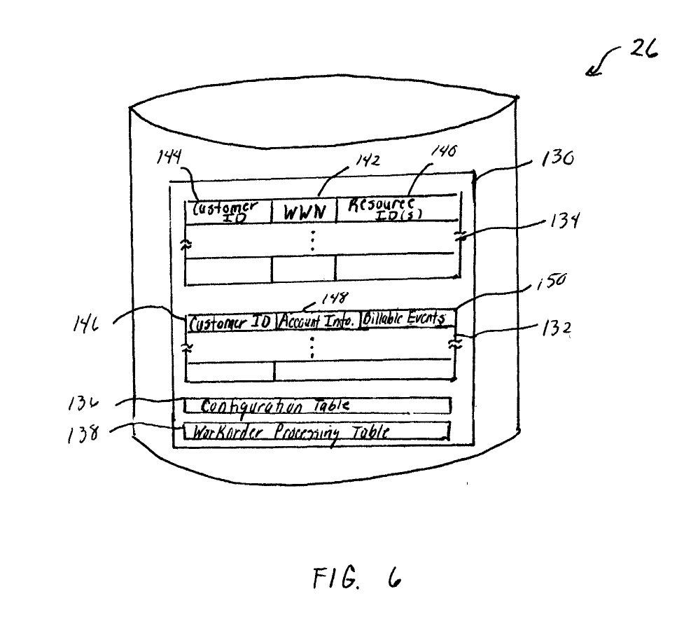

FIG. 5 shows a simple system configuration 100, with a detailed view of the SPMS server software 102. The SPMS software 102 includes a number of components, including an SPMS registration application (SRA) 104, which resides in a tool repository on the server 12, but is executed on each CxSP server 18 attached to the storage 24, and a Web server 106. Also included are various daemons, including a configuration poller 108, a scratch pad configuration poller 110, a metering agent 112, an alert agent 114, “plug-in” modules 115, as well as services 116. The SPMS software 102 further includes utilities 117, for example, where Symmetrix storage systems are used, a Symmetrix Application Program Interface (API) and/or Command Line Interface (CLI) 118 and Volume Logix API/CLI 120, as well as EMC Control Center (ECC) and scratch pad utilities (not shown). Further included in the software 102 is a link 122 to the database 26 and a Web page repository 124.

It will be appreciated from the system depiction of FIG. 5, as well as FIGS. 1-3, that the SPMS server is not directly connected to the servers 18 that use the storage 24. Because the SPMS server needs information about those servers and associated host bus adapters (HBAs) which are connected to the storage, a mechanism which enables an indirect transfer of information from each server 18 to the SPMS server 12 is required. The storage system 24 includes a “scratch pad” 126, which provides for just such a mechanism. In the described embodiment, the SPMS scratch pad is a storage location on the storage system 24 that is used as a temporary holding device through which information is exchanged between the servers 18 and the SPMS server 12. This storage location can be either on the storage media (e.g., on a disk) or in memory of the storage system 18, or any other device “owned” by the xSP and to which the server 18 has access. A scratch pad utility (not shown) is used to read and write to the SPMS scratch pad 126.

The SPMS Web server 106 serves HTML pages to CxSP administrators as well as xSP administrators. The Web server architecture is made up of the following three areas: i) a user domain configuration module, which determines which users can access the Web server 106 and what permissions they have; ii) “back-end” modules which correlate to all of the software logic needed to access the Web pages, execute scripts, etc.; and iii) an external tool repository that contains tools that can be run on the CxSP machines, e.g., the SRA 104, as well as value-added (and chargeable) software for the CxSP to download and run on CxSP servers.

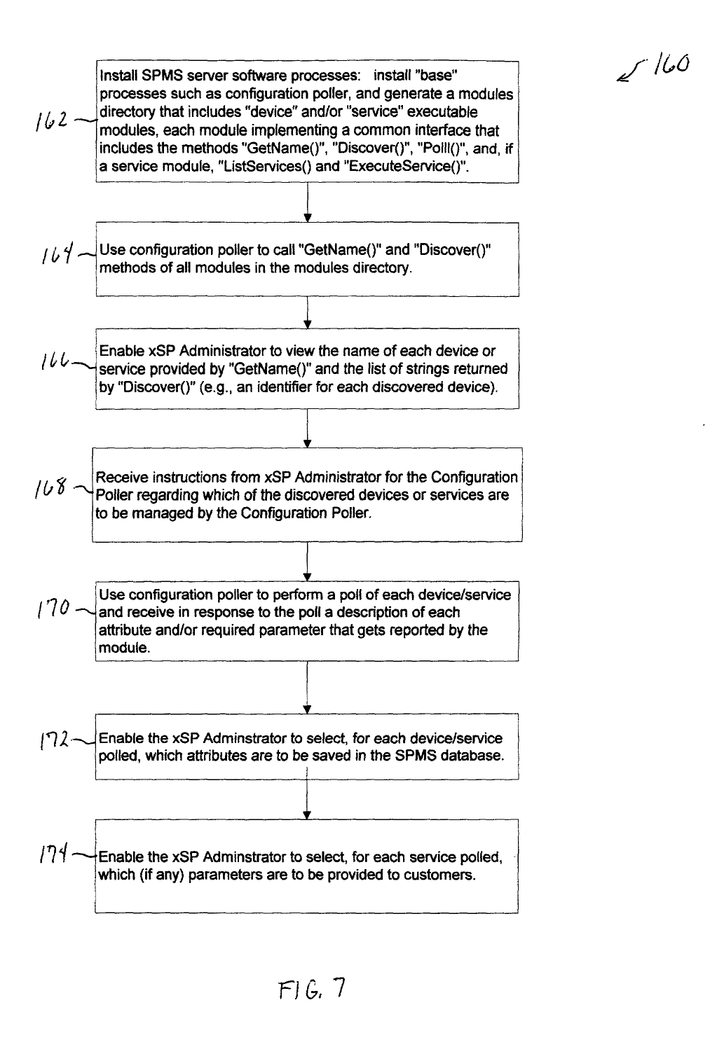

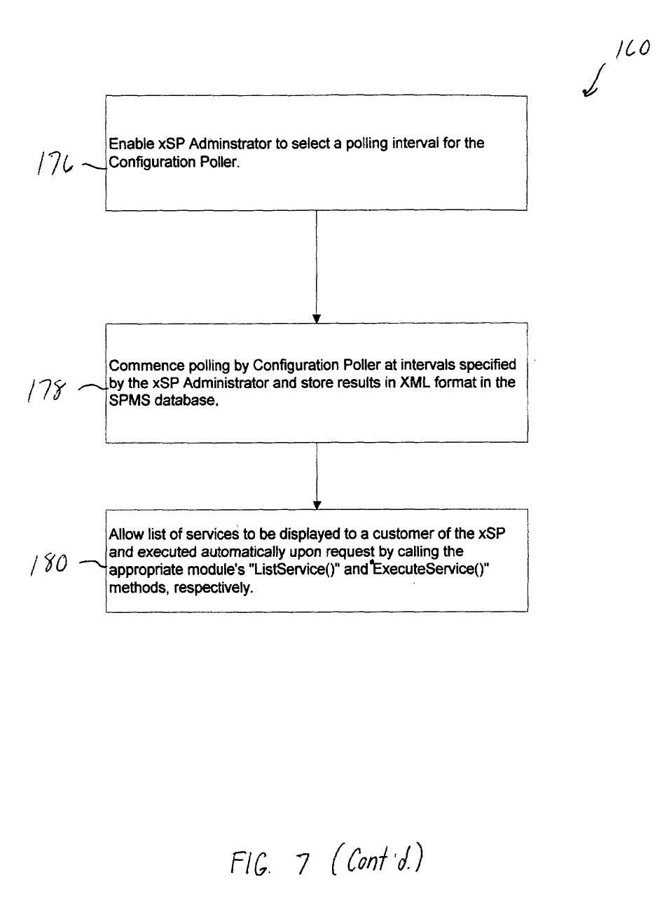

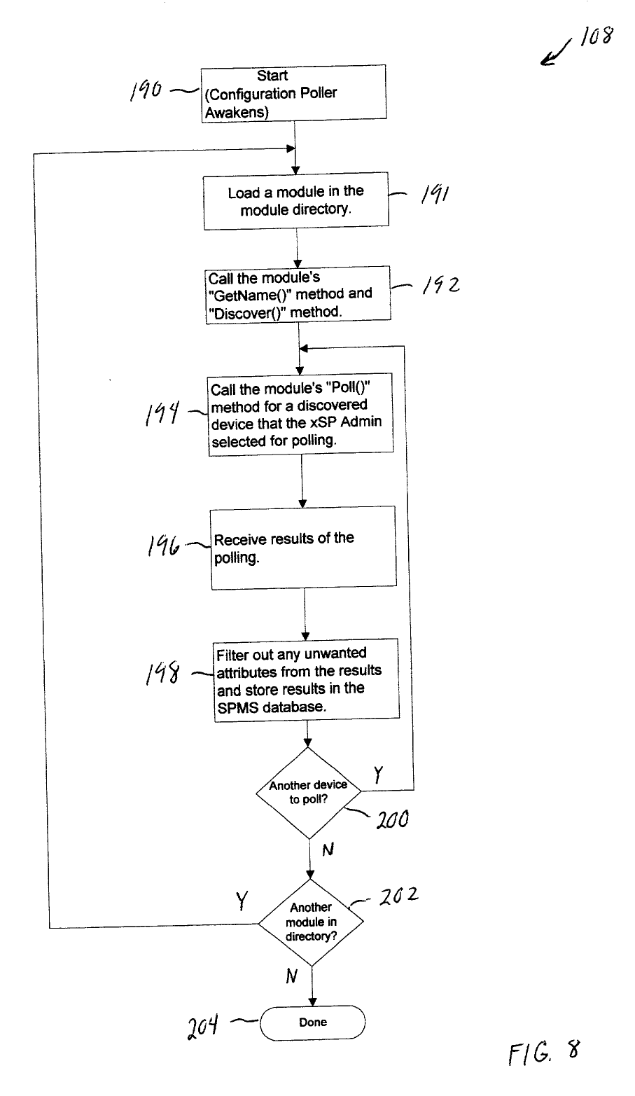

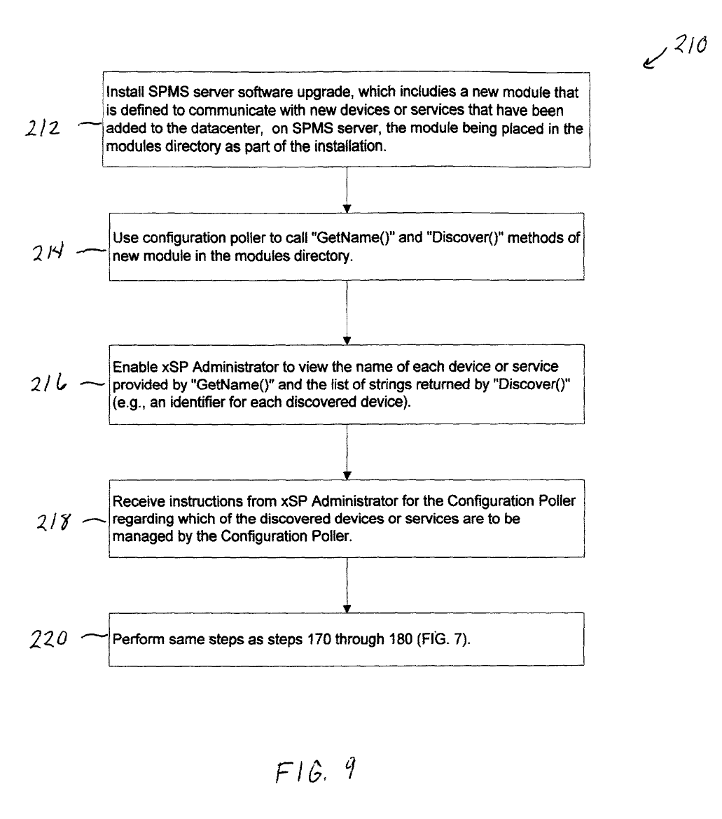

The configuration poller 108 is a process that constantly polls the ports to discover new Symmetrix units that have been added to the xSP site and checks for changes in currently managed Symmetrix units. Any additions are stored in the database and configurations that change are updated in the database. In one embodiment, the configuration poller 108 uses the plug-in modules 115 to perform the polling function, as will be described later with reference to FIGS. 7-12. Although the configuration poller 108 is shown as monitoring only Symmetrix devices, it can be used to monitor any resource managed by the SPMS server 12, as discussed below.

The scratch pad poller 110 is a process whose job it is to poll all connected Symmetrix scratch pads, and is used to collect in-bound scratch pad information as well as direct outbound information to the scratch pad 126. In particular, it continually checks for transmit requests from registration applications. It retrieves each incoming request, validates the user and, if a valid request, causes the registration information to be stored in the database and a status to be returned to the registration application via the scratch pad, as will be described. Additionally, if the scratch pad poller detects a new Symmetrix, it creates a scratch pad for that Symmetrix. The scratch pad poller polling interval is user-defined.

The metering agent 112 is responsible for sampling the latest storage system configuration information for the purpose of storing metering records in the SPMS database 26. This information could be, for example, a daily snapshot of the storage system configurations, or more frequent snapshots of storage system performance information. The metering agent 112 performs the following tasks. It finds all connected storage systems at start-up, and stores the IDs of those systems in the database 26. It creates “meter-able” objects or class files, converts the objects to XML, and stores the XML into the SPMS database 26. The metering agent may choose to store the objects directly in the database or go through the SPMS Web server 106. The “meter-able” objects can be, for example, directors, ports, disks, and volumes. The metering agent is programmed to wake up at a user-defined interval.

The SPMS server 12 employs a mechanism for defining thresholds based on available and allocated capacity. The alert daemon 114 is responsible for monitoring these thresholds and sending out email alerts when they are triggered. The alert daemon 114 awakens periodically, and examines the precondition for each alert in an ALERTS table maintained in the database 26. This is done through database operations (i.e., the alert daemonl 14 will rely on the configuration poller 108 to keep the database view of the configuration up-to-date). The alert daemon 114 may be generalized to allow alerts to be defined by plug-in Java classes.

The daemons can execute as separate processes or as individual threads inside a single process.

The services 116 include such services as an Oracle DB engine, Oracle reporting services and notification services. Other services can include configuration, backup, mirroring, and so forth.

The SPMS server uses the Symmetrix API and/or CLI 118 to gather configuration and performance information from the Symmetrix. For example, the CxSP server administrator may wish to query the SPMS server 12 about the health of the devices on the server. When this request hits the Web server 106, the SPMS server 12 makes an API call to the appropriate storage system 24 to fetch the information. The SPMS server 12 uses Volume Logix utilities 120 for both viewing and setting WWN-to-volume mapping information.

The SPMS server 12 uses the link 122 to access the Oracle database 26 in order to store customer account and billing information, storage system utility and performance information, as well as other information, in the database.

The Web page repository 124 stores HTML Web pages that the Web server 106 serves to the clients, whether they be CxSP administrators or xSP administrators. These Web pages thus take input from the xSP or CxSP user in response to requests to create user accounts, assign storage to servers, and other requests. For example, the Web pages allow the user to run reports to view all of the “meter-able” aspects of assigned storage. Certain HTML pages can allow for the export of information to a third party tool such as a billing application. In one embodiment, style sheets take database information in an XML form and generate a display for the user.

FIG. 6 illustrates the database 26 in some detail. The database 26 includes various tables 130 that are created and maintained by the SPMS server 12. The tables include a customer account table 132, a customer-resource association table 134, one or more configuration tables 136 and one or more work order processing tables 138, among others (not shown). The customer-resource association table 134 includes a field or fields for storing resource identifiers 140, an equipment identifier field 142 for identifying the equipment (that is, server and HBA) connected to the resources specified in field(s) 140. In a Fibre Channel SAN configuration, the identifier stored in the field 142 is the WWN for such equipment. The information in these fields is the result of resource allocation and WWN-to-device mapping by the SPMS server 12 using tools such as the Symmetrix and Volume Logix tools. The table 134 further includes a customer ID field 144 for identifying the customer that “owns” the resources specified in field(s) 140 under the terms of a contract between the customer and the xSP as described earlier. The customer ID field 144 in the table 134 is populated during the registration process. Each entry in the customer account table 132 includes a customer ID field 146 for storing an ID assigned to a customer account, fields for storing account information 148 and fields for storing billable events 150. The fields 146 and 148 are populated with information when a customer's accounted is created by the SPMS server 12. The association of customer ID with the resources that are used by that customer's server (server corresponding to the WWN) in the table 134 allows the SPMS server 12 to track usage of those resources by the customer and generate billable events, which the server 12 stores in the billable events field 150 of that customer's customer account entry in the customer accounts table 132. Preferably, the field 144 stores a customer account ID, but it will be appreciated that any customer information that identifies that customer and allows the SPMS server 12 to access the appropriate entry in the customer accounts table 132 could be used. The billable events can be provided to or are accessed by billing applications. The configuration tables 136 provides the SPMS server 12 with information about the hardware configuration of datacenter 24. The work order processing tables 138 maintain information about user-generated work order requests being processed by the xSP 14.

Referring back to FIG. 5, the SRA 104 is used to associate customers and servers with the storage that they use. Once the customer account has been created, as described earlier, the SRA is installed and executed on each of the servers. The details of an overall registration process 160, including the processing of the registration application at the server 18 and the processing that occurs on the SPMS server side, is described in co-pending U.S. patent application Ser. No. 09/962,790, entitled “Scalable Storage Service Registration Application,” incorporated herein by reference.

Thus, the customer is required to run a registration application on the server in order to associate the already stored WWN of the HBA (for that server) and resource information with the customer's account. This enables billing and reporting services to be provided.

The SRA must accept as input from the CxSP customer information such as username, password, account ID and customer domain information. The SRA must generate information about the server. There are 4 levels of information that could be generated, including: 1) customer information (username, password, domain, account ID, etc.); 2) hostname, type and revision, HBA WWNs; 3) per HBA, file system and device mapping information; and 4) third party application information (Oracle, Veritas, etc.) Only the first two levels of information are required.

The basic purpose of the SRA 104 is to associate the HBA WWN running in the CxSP server with a customer, more specifically, a customer account. Other information about the customer's server environment can also be pushed down to the SPMS server 12 (via the scratch pad 126) to present more meaningful information about the customer, as discussed above.

It should be noted that the SRA not only needs to run at initial registration, but it also needs to run after any configuration change and/or file system/volume change. It could be implemented to run automatically as a daemon or boot-time script.

The WWN is a Fibre Channel specific unique identifier that is used at both ends and facilitates association of both end points (point-to-point). Preferably, the switch 18 is FC, and therefore the unique identifier is WWN and thus described; however, the switch could be a SCSI MUX, or even a network switch if NAS is part of the infrastructure.

The scratch pad could be used for other types of communication as well. For example, a customer may want the storage allocation to be extended when the free space is below a certain threshold. The server may have a process to monitor free space and put a report in the mailbox. The SPMS retrieves the report and looks at the customer's policy, initiating a workorder to increase the size of the volume if the free space is below threshold. It could also be used to exchange information about billing events, information about server (QoS), as well as other types of information.

As mentioned earlier, there are various utilities 117 needed for proper SPMS server operation. In a Symmetrix environment, they include, for example, the Symmetrix API/CLI 118 for gathering configuration information, Volume Logix 120 for gathering/setting HBA-to-volume mapping information, as well as ECC components for use by the xSP administrator in monitoring the Symmetrix and a utility for managing the SPMS scratch pad.

As discussed above, the configuration poller 108 extracts configuration information for SPMS managed resources (that is, devices and/or services) from the database 26, obtains resource configuration information, including changes as well as information about new devices and services added to the datacenter (step 184), and updates the database configuration information for configuration changes and managed resource additions as necessary. The configuration poller 108 may be implemented to directly monitor specific managed devices and services directly, but such an implementation requires modification to the configuration poller 108 each time new resources are added to the datacenter for customer use. Preferably, the xSP 14, and in particular, the SPMS server 12, instead employ a flexible, modular approach to resource configuration management.

FIG. 7 illustrates an initial device and storage services installation and configuration management operation 160 that uses the configuration poller 108 in conjunction with the plug-in modules 115. Referring to FIG. 7, the server 12 performs the installation of the SPSM server software (step 162). This initial installation includes installing “base” SPMS processes such as the configuration poller 108, as well as generating a directory of the device and storage service executable modules 115. The modules 115 implement a common interface that includes the following methods:

Module Methods

String GetName( );

String [ ] Discover ( );

Error Poll (String Device, XML Result);

XML ListServices( );

Error ExecuteService(XML Action)

The “GetName( )” method identifies the type of resource that the module represents and with which the module is capable of communicating. The “Discover( )” method identifies any connected resource of this type. The “Poll( )” method polls the resource to collect attribute information stored on that resource. The “ListService( )” method provides a list of services and required parametersthat are necessary to execute each service. The “ExecuteService( )” method, when called, causes the execution of a service in response to a request (i.e., workorder) from a customer.

Still referring to FIG. 7, the server 12 uses the configuration poller 108 to call the “GetName( )” and “Discover( )” methods of all modules in the modules directory (step 164). The server 12 enables the xSP Administrator to view the name of each device and/or service provided by “GetName( )” and the list of strings returned by “Discover( )” (such as an indentifier for each discovered device) (step 166). The server 12 then receives instructions from the xSP Administrator for the configuration poller 108 regarding which of the discovered devices or services are to be managed by the configuration poller 108 (step 168). The server 12 uses the configuration poller to call the “Pollo” method in order to perform a poll of each device and/or service, and receives in response to the poll a description of each attribute and/or required parameter that is reported by the module (step 170). The server 12 enables the xSP Administrator to select, for each device/service polled, which attributes are to be saved in the SPMS database 26 (step 172). In addition, the server 12 enables the xSP Administrator to select, for each service polled, which (if any) parameters are to be provided to customers. The server 12 also enables the xSP Adminstrator to select a polling interval for the configuration poller (step 176). The server 12 commences polling by the configuration poller (using the “Poll( )” method) at intervals defined by the xSP Administrator and stores the results in XML format in the SPMS database (step 178). The server 12 allows a list of services to be displayed to a customer and executed automatically upon request (by that customer) by calling the appropriate module's “ListService( )” and “ExecuteService( )” methods, respectively (step 180).

Referring to FIG. 8, the operation of the configuration poller 108 is shown in detail. The configuration poller 108 awakens (step 190) and loads a module in the module directory (step 191). The configuration poller 108 calls the module's “GetName( )” method and “Discover( )” method (step 192). The configuration poller 108 then calls the module's “Pollo” method for a discovered device that the xSP Administrator selected for polling (step 194). The configuration poller 108 receives the results of the polling (step 196). The configuration poller 108 filters out any unwanted attributes from the results and stores the filtered results in the SPMS database 26 (step 198). The configuration determines if there is another device to polled (again, based on the xSP Administrator's selection, as was discussed earlier in reference to FIG. 7) (step 200). If it determines that there is another device to be polled, the configuration poller 108 returns to step 194 to poll the next device. If the configuration poller 108 determines that there are no other devices to be polled, the configuration poller 108 determines if it has iterated through all of the modules in the directory (step 202). If it determines that it has not, it returns to step 191. Otherwise, the configuration poller 108 is finished with its work and waits for the next polling interval (step 204).

Turning now to FIG. 9, a process of upgrading the managed devices and services 210 when a new device or service has been added to the datacenter is shown. The process 210 begins by installing on the SPMS server the SPMS server software upgrade package, which includes a new module that is defined to communicate with new devices or services that have been added to the datacenter, with the new module being placed in the existing modules directory (step 212). The process 210 uses the configuration poller 108 to call “GetName( )” and “Discover( )” methods of the new module in the modules directory (step 214). The process 210 enables the xSP Administrator to view the name of each device or service provided by “GetName( )” and the list of strings returned by “Discover( )”. The process 210 receives instructions from the xSP Administrator for the configuration poller 108 as to which of the discovered devices or services is to be managed (step 218). As indicated at step 220, the process 210 then performs the same steps as steps 170 through 180 shown in FIG. 7.

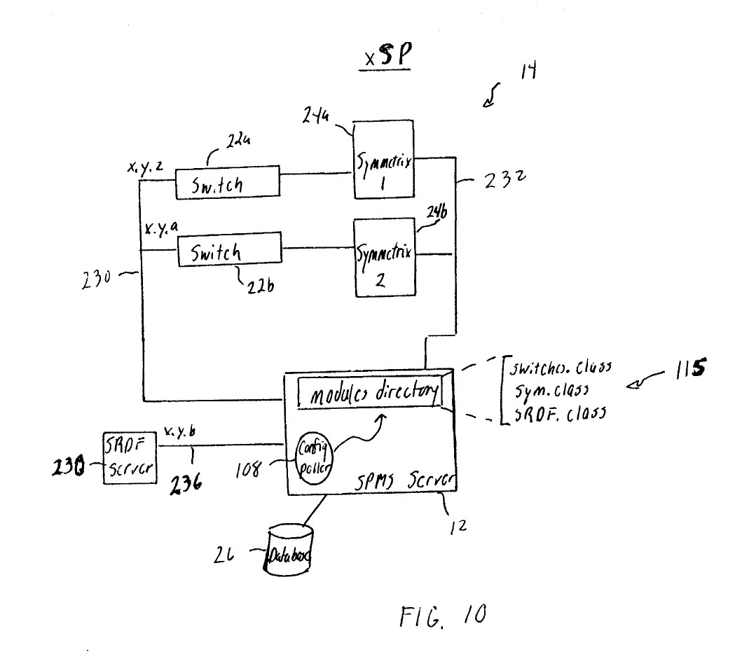

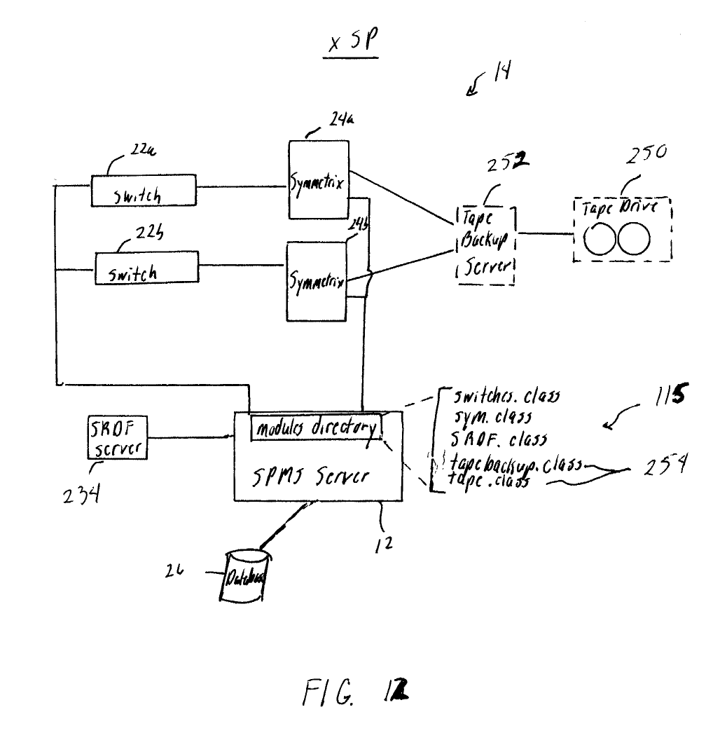

FIGS. 10-12 illustrate a simple example of adding a new device and service to a datacenter in an xSP using the processes described above with reference to FIGS. 7-9. FIG. 10 shows an existing xSP 14 and its datacenter, and FIG. 12 shows the xSP after a new tape drive and tape backup service have been added to the datacenter. The xSP shown in FIG. 10 is similar to that of FIG. 1, but the switches reside in the xSP environment and are included among the devices that are available for customer allocation.

Referring to FIG. 10, the xSP 14 includes an SPMS server 12 that is connected to managed devices, including the Symmetrix units 24a, 24b and the switches 22a, 22b, as well as a managed service, shown as a Symmetrix Remote Data Facility (SRDF) server/server process 230. Although the SRDF software is depicted as residing on a separate server, the SRDF software could just as easily reside on the SPMS server 12. It could also reside on the Symmetrix units 24. The SPMS server 12 is coupled to the Symmetrix units 24 by a Fibre Channel connection 232. Other types of connections, including different cabling configurations, e.g., those that include switches, could be used used to connect to the Symmetrix units as well. The SPMS server 12 isconnected to switches 22 and the SRDF server/server process 230 via respective TCP connections. The switch 22a resides at an IP address “x.y.z”, the switch 22b resides at an IP address “x.y.a” and the SRDF server 230 resides at an IP address “x.y.b”. The connections between the switches 22 and hardware residing in the CxSP have been omitted from this figure (as well as FIG. 12) for simplification.

In addition to installing the configuration poller on the server 12, the installation of the SPMS server software creates a modules directory of modules (or classes) 115 corresponding to the managed resources, including a switches.class, sym.class and SRDF.class. The switches.class, sym.class and SRDF.class define how to communicate with the corresponding resources, that is, the switches 22, Symmetrix units 24 and SRDF service 230, respectively. Preferably, each “.class” file is implemented as a JAVA module. Other suitable implementations could be used to produce the executable software modules, however.

The configuration poller 108 is responsible for communicating with all the hardware and services installed in the datacenter and recording that the resources are present in the datacenter so that those resources can be assigned to customers and the customers can be billed for using those resources. Initially, the configuration poller 108 has no knowledge of which hardware devices and services reside in the datacenter. It uses the modules directory to determine that information. The configuration poller 108 loads modules one by one and uses the modules' methods to find out from each module that module's identity (GetName( )) and to direct the module to ascertain which devices or services that module manages, as well as provide information, e.g., attributes, about the managed resources. The configuration poller then reports the information on the discovered resources to the xSP Administrator.

For example, the configration poller loads the switch.class and calls the “GetName( )” method, which responds that it manages switches. The configuration poller then calls the “Discover( )” routine, which responds that it has found a switch at IP address “x.y.z” and IP address “x.y.a”. The configuration poller either reports the results to the xSP Administrator automatically, or waits for the xSP Administrator to run a report that asks the configuration poller 108 about the “discovered” resources in the datacenter.

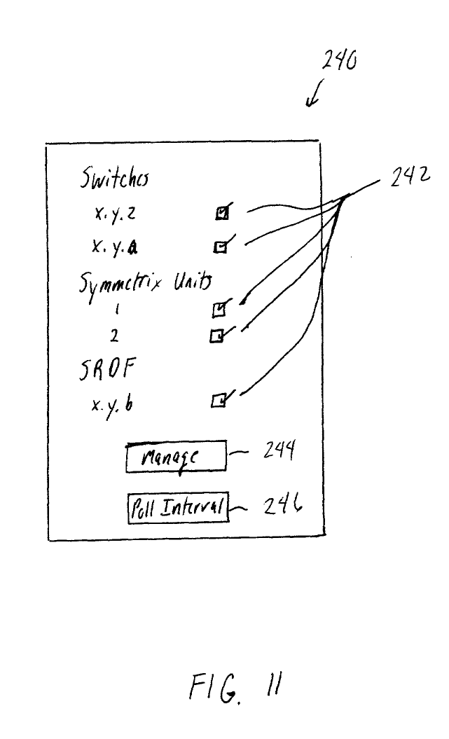

Referring to FIG. 11, the reporting feature can take the form of a report interface, such as the exemplary report/selection GUI screen 240, as shown, or may be implemented in some other manner. The screen 240 allows the xSP Adminstrator to view the discovered resources and select, via check boxes 242, which of those resources are to be managed by the configuration poller 108. The xSP Administrator can then finalize the selection, e.g., by clicking on a button, such as a “manage” button 244. In addition, in the same screen or at a later stage in the process, the xSP Administrator can set a poll interval, e.g., using a poll interval selection button 246, or by defining a polling interval in a parameter field (not shown) or using a textual command. The poll interval specifies the frequency with which the configuration poller 108 polls the selected resources.

Preferably, although not shown in the example, the report includes device/service attributes, as well as parameters to be specified by a customer for a particular service that the customer wishes to request. The xSP Administrator may select all or some of the attributes as attributes to be saved in the SPMS database 26.

Thus, once the resource management selection has been made, the configuration poller 108 wakes up and loads a “.class”, for example, the switch.class. Continuing to use this example, the configuration poller 108 determines that the loaded module manages switches and uses the module to discover all the TCP connections to those switches. It then polls a first device, such as the switch 24a at IP address “x.y.z”. The results, which indicate state and attributes information, are returned in some format that is suitable for database storage, or can be converted to such a format. Preferably, the format in which the information is returned to the configuration poller 108 is XML. The configuration poller 108 stores the XML results in a database record. Once stored in the database, this hardware/service configuration information record can be associated with a customer, as earlier described.

The device/service being polled may produce results in XML, or, e.g., in the case of certain devices, e.g., the Symmetrix, whose APIs are written in C code, in some other format. In the latter case, the module further implements an appropriate conversion routine to convert the results from the native format to XML.

The xSP Admininstrator, upon receiving the results, can also modify “on-the-fly” the selection of attributes to be saved (uncheck a box, e.g., don't save the number of ports).

Referring now to FIG. 12, suppose that the xSP wishes to make available to its customers an additional resource or resources. In the example shown, the new resources to be added to the datacenter include tape storage 250 and a tape backup service 252 to perform a backup of data stored on the Symmetrix units 24, that is, to pull the data from the Symmetrix units and stream the data into the tape storage 250. The xSP 14 makes the appropriate hardware connections and acquires the SPMS software upgrade, which includes new “plug-in” modules 254 for the new device (tape.class) and service (tapebackup.class).

During the installation of the upgrade package, the new classes are placed in the existing modules directory. The base software, including the configuration poller 108 (not shown here), remains unchanged. The configuration poller 108 can now use the updated modules directory to find the new hardware and service, and allow the xSP Administrator to select them in the manner discussed above. Thus, the modularity of the device/service configuration management provides for a seamless upgrade process.

Moreover, customizable events can be built around the executable modules by triggering on the values of certain attributes or parameters, or on the method calls themselves. The eventing routines can be part of the functionality defined by the modules themselves or part of the base SPMS software, or may be included in separate plug-in modules.

One possible implementation for eventing in this architecture can occur when the xSP administrator is selecting which attributes to store during a poll. At this point the xSP administrator can, for each attribute, specify a “threshold” or “range” that is worthy of an event notification. For example, if one of the attributes of a disk device is the percentage of time that the disk is busy, the xSP administrator can specify that if this percentage climbs above a threshold value, e.g., 90%, then an event should be triggered. In addition to specifying this value, the xSP administrator can also specify what program should generate the event (for example, an email will be generated and sent to the administrator). Once the xSP administrator has entered this information into the SPMS system and saved it, the configuration poller 108, or perhaps another piece of software, can examine each poll to determine whether or not any of the values that the xSP administrator is interested in is now worthy of generating an event.

Other aspects of the SPMS architecture not described above may be implemented according to techniques described in co-pending U.S. patent application Ser. No. 09/962,408, entitled “Mediation Device for Scalable Storage Service,” incorporated herein by reference.

It is to be understood that while the invention has been described in conjunction with the detailed description thereof, the foregoing description is intended to illustrate and not limit the scope of the invention, which is defined by the scope of the appended claims. Other embodiments are within the scope of the following claims.

For example, although in the described embodiment the modules correspond to data storage resources, such as storage devices, storage network components (e.g., switches) and storage-related services, that are being managed within the context of an xSP environment in which storage resources are made available to customers as a service, the modules can be defined to represent any type of managed resource, e.g., a network service being managed by a network accounting system.

What is claimed is:

1. A method of managing resources, comprising:
connecting to the resources;
providing executable modules corresponding to the resources, the modules each implementing a common interface and corresponding to a different one of the resources;
making calls to the common interface in each of the executable modules to cause the executable modules to return information about the corresponding resources; and
storing the information about the corresponding resources in a database.

2. The method of claim 1, wherein the resources comprise data storage resources.

3. The method of claim 2, wherein the data storage resources reside in a datacenter controlled by a storage service provider.

4. The method of claim 3, furthering comprising presenting the information to an administrator of the storage service provider.

5. The method of claim 4, wherein the information comprises data storage resource attributes.

6. The method of claim 5, further comprising enabling the administrator to select, for a given data storage resource, which of the data storage attributes are to be stored in the database.

7. The method of claim 1, wherein the executable modules comprise JAVA classes.

8. The method of claim 4, further comprising:
generating a directory of the executable modules; and
placing each of the executable modules in the directory.

9. The method of claim 8, wherein the common interface comprises a set of methods.

10. The method of claim 9, wherein the methods include a first method that, when called, cause the executable module to identify the class of resources monitored by that executable module, and a second method that, when called, causes the executable module to discover any resources within the identified class that are connected.

11. The method of claim 10, wherein the methods further include a third method that, when called, causes the executable module to poll the resources that were discovered by the executable module.

12. The method of claim 11, wherein results of the polling are provided in XML format.

13. The method of claim 11, wherein the results of the polling are provided in a format other than XML and the executable module performing the polling converts the results of the polling to XML format.

14. The method of claim 11, wherein the methods further comprise a fourth method that, when called, causes the executable module to return a list of services and associated parameters.

15. The method of claim 12, wherein the methods further comprise a fifth method that, when called, causes the executable module to execute a requested one of the services on the list of services.

16. The method of claim 13, wherein making calls to the common interface comprises making a call to the fifth method, and wherein making a call to the fifth method comprises specifying values of parameters associated with the requested one of the services received from a customer of the service provider.

17. The method of claim 5, further comprising:
adding a new data storage resource to the datacenter;
connecting to the new data storage resource;
providing a new one of the executables modules to correspond to the new data storage resource; and
placing the new one of the executable modules in the directory.

18. The method of claim 17, wherein making calls to the common interface comprises making calls to a common interface in the new one of the executable modules.

19. A computer program product residing on a computer-readable medium for managing resources, the computer program product comprising instructions causing a computer to:
connect to the resources;
provide executable modules corresponding to the resources, the modules each implementing a common interface and corresponding to a different one of the resources;
make calls to the common interface in each of the executable modules to cause the executable modules to return information about the corresponding resources; and
store the information about the corresponding resources in a database.

20. A system for managing resources comprising:
a server configured to execute software for managing resources to which the server is connected; and
wherein the software includes resource-specific executable modules each corresponding to a different one of the managed resources and a resource-independent device configured to use the executable modules to monitor changes in configuration and attributes information associated with the corresponding managed devices.
